(19) United States
(12) Patent Application Publication
(10) Pub. No.: US 2024/0346518 A1
(43) Pub. Date: Oct. 17, 2024

(54) DIGITAL CUSTOMER CONSENT ENGINE

(71) Applicant: Wells Fargo Bank, N.A., San Francisco, CA (US)

(72) Inventors: Jasmine de Gaia, Lewis Center, OH (US); Sailesh Mantha, Charlotte, NC (US); Edward E. Miranda, Waukee, IA (US); Tapan Shah, Charlotte, NC (US)

(21) Appl. No.: 18/300,861

(22) Filed: Apr. 14, 2023

(51) Int. Cl. G06Q 30/01; G06Q 30/0201

(52) U.S. Cl. CPC G06Q 30/01; G06Q 30/0201

(57) ABSTRACT

Techniques are described in which a digital customer consent engine maintains one or more rules configured to identify one or more customer contact restrictions from customer data. The digital customer consent engine, in response to receipt of the customer data of a plurality of customers at a point in time, applies the one or more rules to the customer data to identify the one or more customer contact restrictions for one or more customers of the plurality of customers. The digital customer consent engine outputs a first report comprising a plurality of customer identifiers and that includes, for a particular customer identifier for a particular customer, an indicator of which customer contact restrictions apply to the particular customer and outputs a second report comprising a list of customer identifiers as a subset of the plurality of customer identifiers that are permitted to be contacted for a marketing campaign.

### TECHNICAL FIELD

This disclosure relates to computer system and, in particular, computer systems that store and analyze customer data.

### BACKGROUND

A component of marketing is determining whether potential customers can be contacted. Organizations may need to comply with a variety of government regulatory requirements for contacting customers, as well as the preferences of current customers.

### SUMMARY

In general, the disclosure describes a computing system configured to create and maintain rules to identify customer contact restrictions from customer data, and apply the rules to current customer data of a plurality of customers at a point of time to identify the customer contact restrictions in the current customer data. As used throughout this disclosure, the plurality of customers includes current customers of an organization's one or more products and prospective or potential customers of the organization. The computing system generates and outputs reports including customers identifiers for the plurality of customers and, for each particular customer identifier, indicators that align with the customer contact restrictions associated with the particular customer. For a particular marketing campaign, the computing system generates and outputs additional reports that include a list of customer identifiers that are permitted to be contacted for the marketing campaign.

More specifically, in response to a request to generate a report of customers that may be contacted for a marketing campaign, the disclosed computing system may select one or more rules created to identify customer contact restrictions. The disclosed computing system applies the one or more rules to the current customer data stored in a database in order to identify the contact restrictions for each customer in the current customer data. Updates to the customer data, which may be received daily, weekly, continuously, or the like, may cause the customer contact restriction results to change. As such, the computing system may apply the one or more rules to the updated customer data, daily, weekly, or the like, in order to provide updated reports on customer contact restrictions for potential use in the marketing campaign.

The disclosed computing system is configured to generate business logic abstracted from code for configuration by marketing teams. The disclosed system may receive configurations of abstracted business logic from user computing devices and process the configured business logic. The disclosed system may receive configured business logic such as state or federal regulatory requirements for contacting customers, as well as contact preferences of current customer (e.g., “Don't contact me with offers by email”). The disclosed system processes the configured business logic into rules for identifying customer contact restrictions based on the customer characteristics. The disclosed system then applies the rules to one or more databases to identify customer contact restrictions for each of the customers and outputs reports of the customers. The disclosed system outputs a report that lists the customers of the customer data and associated customer contact restrictions. In this way, the disclosed system may log the one or more reasons why each customer with a contact restriction has the contact restriction.

The techniques of this disclosure may provide one or more advantages. The ability to automate the filtering of customers by contact restrictions may enable marketing teams to stay up to date with regulatory requirements for customer contact and to ensure compliance with customer contact preferences. The ability to generate rules for identifying contact restrictions for customers from business logic abstracted away from code may enable accelerated execution of marketing campaigns by removing the need for software developers to write code necessary to implement the identification of contact restrictions for individual customers.

In one example, this disclosure is direct to a method comprising maintaining, by a computing system, one or more rules configured to identify one or more customer contact restrictions from customer data, receiving, by the computing system, customer data of the plurality of customers at a point in time, applying, by the computing system, the one or more rules to the customer data to identify the one or more customer contact restrictions for one or more customers of the plurality of customers, outputting, by the computing system, a first report comprising a plurality of customer identifiers for the plurality of customers, and for a particular customer identifier for a particular customer, an indicator of which customer contact restrictions apply to the particular customer, and outputting, by the computing system, a second report comprising a list of customer identifiers as a subset of the plurality of customer identifiers that are permitted to be contacted for a marketing campaign.

In another example, this disclosure is directed to a computing system, comprising a memory, and one or more processors in communication with the memory. The one or more processors configured to maintain one or more rules configured to identify one or more customer contact restrictions from customer data, receive customer data of the plurality of customers at a point in time, apply the one or more rules to the customer data to identify the one or more customer contact restrictions for one or more customers of the plurality of customers, output a first report comprising a plurality of customer identifiers for the plurality of customers, and for a particular customer identifier for a particular customer, an indicator of which customer contact restrictions apply to the particular customer, and output a second report comprising a list of customer identifiers as a subset of the plurality of customer identifiers that are permitted to be contacted for a contact campaign.

In a further example, this disclosure is directed to a non-transitory computer-readable storage medium comprising instructions that, when executed, cause one or more processors to maintain one or more rules configured to identify one or more customer contact restrictions from customer data, receive customer data of the plurality of customers at a point in time, apply the one or more rules to the customer data to identify the one or more customer contact restrictions for one or more customers of the plurality of customers, output a first report comprising a plurality of customer identifiers for the plurality of customers, and for a particular customer identifier for a particular customer, an indicator of which customer contact restrictions apply to the particular customer, and output a second report comprising a list of customer identifiers as a subset of the plurality of customer identifiers that are permitted to be contacted for a contact campaign.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system including a digital customer consent engine configured to create, manage, and apply rules configured to identify customer contact restrictions from customer data for use in marketing campaigns, in accordance with one or more techniques of this disclosure.

FIG. 2 is a block diagram illustrating an example data analytics system configured to execute the digital customer consent engine from FIG. 1.

FIG. 3 is a block diagram illustrating an example of the digital customer consent engine from FIG. 1 in greater detail.

FIG. 4 is a block diagram illustrating an example operation of a rule authoring environment of the digital customer consent engine from FIG. 1.

FIG. 5 is a block diagram illustrating an example operation of the digital customer consent engine from FIG. 1 configured to maintain rules configured to identify customer contact restrictions and apply the rules to customer to data to identify customers having the customer contact restrictions, in accordance with one or more techniques of this disclosure.

FIG. 6 is a flowchart illustrating an example operation of a digital customer consent engine, in accordance with one or more techniques of this disclosure.

FIG. 7 is an example user interface of the digital customer consent engine illustrating an example listing of rules configured to identify customer contact restrictions.

### DETAILED DESCRIPTION

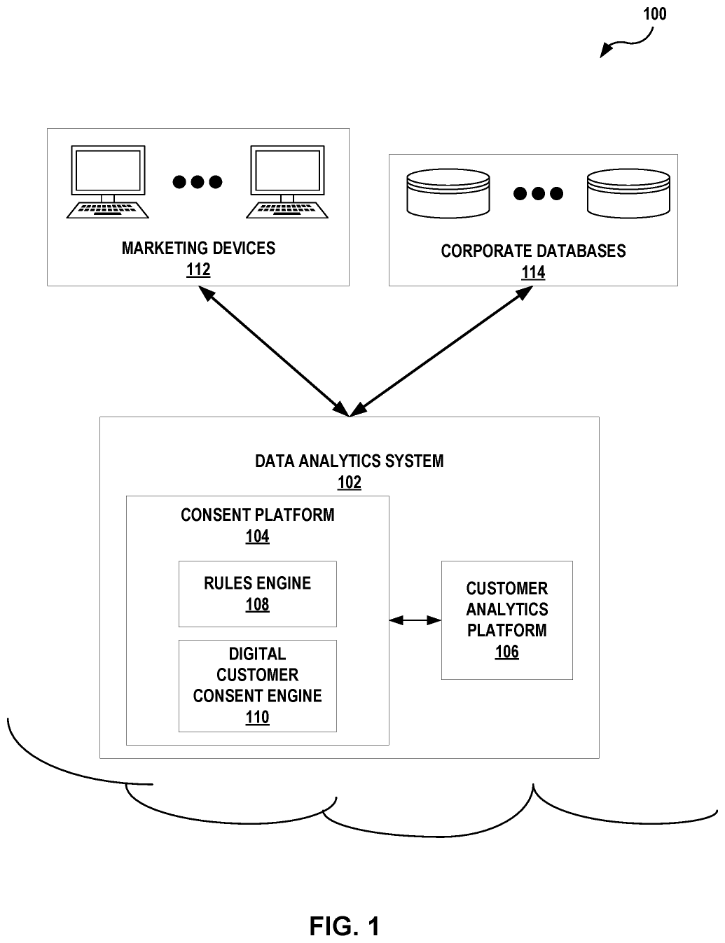

FIG. 1 is a block diagram illustrating an example system 100 including a digital customer consent engine 104 configured to create, manage, and apply rules configured to identify customer contact restrictions from customer data for use in marketing campaigns, in accordance with one or more techniques of this disclosure. As illustrated in FIG. 1, system 100 includes marketing devices 112, corporate databases 114, and data analytics system 102 executing digital customer consent engine 104 and customer analytics platform 106. Data analytics system 102 may be in communication with marketing devices 112 and corporate databases 114 over one or more private or public networks via one or more protocols or communication channels such as Wi-Fi®, Ethernet, fiber optic, and/or other methods of communication.

Marketing devices 112 may include computers, laptops, tablet computers, thin client devices, and other such computing devices used by data analysts of a corporation or other organization. Marketing devices 112 may communicate with data analytics system 102 to request the generation of reports of customer identifiers. Marketing devices 112 may communicate with data analytics system 102 over a network such as private network within a company or a public network. Marketing devices 112 may additionally communicate with data analytics system 102 to manage the rules used to generate the reports of customer identifiers.

Marketing device 112 may receive user input consistent with a configuring of business logic. Marketing devices 112 may receive user input such as user interaction with a graphical user interface (GUI), a user selecting an item from a drop-down menu, a user typing marketing teams and Boolean logic, and the like consistent with the configuring of business logic. Marketing devices 112 may encode the user input into business logic consisting of software representative of the user configurations. Marketing devices 112 may provide the user input data to data analytics system 102.

Corporate databases 114 may include a plurality of databases. Corporate databases 114 may include a plurality of local databases, data center storage nodes, public or private cloud storage systems, systems of record (SoRs), and other storage facilities in which large data sets are stored. Corporate databases 114 may store corporate data on one or more storage mediums such as hard disk drives, solid state storage, and tape storage. Corporate databases 114 may store corporate data such as customer data (e.g., data on mortgages, customer financial statistics, and other customer data).

Data analytics system 102 may provide a variety of data analysis processes accessible by marketing devices 112. Although illustrated in FIG. 1 as including a single device executing a single digital customer consent engine 104 and a single customer analytics platform 106, data analytics system 102 may comprise a centralized or distributed system of computing devices, such as desktop computers, laptops, workstations, wireless devices, cloud-based compute nodes, network-ready appliances, file servers, print servers, or other devices, configured to execute and/or support one or more instances of digital customer consent engine 104 and customer analytics platform 106.

In the example of FIG. 1, data analytics system 102 executes customer analytics platform 106. Customer analytics platform 106 may provide users, such as the users of marketing devices 112, with a unified exploratory environment to access and analyze data. Customer analytics platform 106 may manage the feeding and preprocessing of data into digital customer consent engine 104. For example, customer analytics platform 106 may manage how frequently data is provided to digital customer consent engine 104 and preprocess the data received from corporate databases 114.

In the example of FIG. 1, data analytics system 102 executes digital customer consent engine 104. Digital customer consent engine 104 may include one or more software components, such as rules engine 108 and consent utility 110, executing on one or more computing devices within data analytics system 102. Digital customer consent engine 104 may include rules engine 108 that applies a plurality of rules used to identify customer contact restrictions in customer data. Consent utility 110 may manage the operation of rules engine 108 and movement of data through one or more operations. Consent utility 110 may store rules that identify one or more customer contact restrictions such as do-not-call lists, state and federal regulatory requirements, and customer contact preferences among other contact restrictions.

Digital customer consent engine 104 may obtain customer data from one or more sources such as corporate databases 114 and customer analytics platform 106 to process customer data using rules for contact restrictions to identify applicable customer contact restrictions. Digital customer consent engine 104 may obtain customer data that is organized by customer identifiers. Customer analytics platform 106 may organize and pre-process customer data before providing the customer data to digital customer consent engine 104. In an example, digital customer consent engine 104 requests customer data from corporate databases 114. Data analytics server 102 may obtain the customer data from corporate databases 114, however the customer data may not be organized by the customer identifiers used by digital customer consent engine 104. Customer analytics platform 106, responsive to determining that the data is not organized for use digital customer consent engine 104. preprocesses the data to organize it for digital customer consent engine 104.

Digital customer consent engine 104 may enable users of digital customer consent engine 104, such as marketing devices 112, to configure business logic that is an abstraction of rules used to implement customer contact restrictions. Digital customer consent engine 104 may generate data representative of a user interface, such as a GUI, for the users of marketing devices 112 on which to present data comprising abstracted business logic from which digital customer consent engine 104 generates rules for identifying customers. Marketing devices 112 may display, via display devices of marketing devices 112, the user interface including one or more fillable and editable forms, drop-down menus, or the like for receipt of user input for users of marketing devices 112 to configure the business logic.

Digital customer consent engine 104, responsive to the configuration of business logic, may process the business logic into customer rules that implement the business logic. Digital customer consent engine 104 may process the business logic into rules configured to identify contact restrictions for customers. As one example, digital customer consent engine 104 may receive business logic configured to cause an indication that customers residing within the State of Minnesota cannot be contacted by phone call. Continuing this example, digital customer consent engine 104, responsive to the receipt of the configured business logic, processes the business logic into rules configured to indicate customers residing within Minnesota have a customer contact restriction that prevents the contacting of customers by phone.

Digital customer consent engine 104 may apply the rules to the customer data. Digital customer consent engine 104 may apply the rules to and process the customer data on a regular basis (e.g., daily, weekly, monthly). Digital customer consent engine 104 may process the customer data in response to the receipt of new customer data from corporate databases 114. In one example, corporate databases 114 are updated on a daily basis with new customer data at the end of each workday and provide updated customer data to digital customer consent engine 104. Digital customer consent engine 104 may process customer data in real-time as it is streamed from corporate databases 114 to data analytics system 102 and provided to digital customer consent engine 104.

Digital customer consent engine 104, responsive to the receipt of customer data, applies the rules to the customer data received from corporate databases 114. Digital customer consent engine 104 may apply the rules using parallel processing (i.e., splitting the customer data into subsets and simultaneously processing the subsets). Additionally, digital customer consent engine 104 may apply the rules using orders of operations configured by a user or digital customer consent engine 104 may determine the order of operations for applying the rules to the customer data.

Digital customer consent engine 104 may output a report of customer identifiers that lists customers by their associated identifier and any customer contact restrictions associated with each customer. For example, digital customer consent engine 104 may output a report comprising a list of customers organized by customer identifier and indicators of whether the individual customers have any customer contact restrictions. In some examples, the indicators may comprise binary indicators, e.g., Y/N or 1/0, to indicate whether a given customer does or does not have the contact restrictions included on the report. Digital customer consent engine 104 may provide the report to marketing devices 112 for display to users of marketing devices 112. In addition, digital customer consent engine 104 may output a second report that comprises a list of customer identifiers as a subset of customer identifiers that are permitted to be contact for a marketing campaign. In an example, a particular customer has requested not to be contacted by any means for marketing purposes. Digital customer consent engine 104 may provide a report to marketing devices 112 that does not include the customer identifier for the particular customer that has requested not be contacted.

Digital customer consent engine 104 may provide a number of benefits and applications. For example, digital customer consent engine 104 may decrease the length of time necessary to implement the requirements of regulatory changes by reducing the length of time necessary to convert state and federal regulations into rules for identifying customer contact restrictions. In another example, digital customer consent engine 104 may enable faster responses to the receipt of customer data through parallel processing of customer data.

Digital customer consent engine 104 may additionally enable rule creation by users of marketing devices 112. Rather than a user determining the requirements necessary to ensure compliance with customer contact restrictions and providing those requirements to a software team for implementation, digital customer consent engine 104 may enable the user to instead configure the requirements themselves through a user interface displayed by marketing devices 112. Marketing devices 112 may then provide the user's configuration of business logic to digital customer consent engine 104 for implementation rather than to a software development team.

Digital customer consent engine 104 may additionally enable users to make real-time modifications to customer contact restrictions. Digital customer consent engine 104 enables a user of marketing devices 108 to modify the business logic and implement the modified requirements of the marketing campaign without requiring a software development team to recode a program for identifying customer contact restrictions of customers. Digital customer consent engine 104 may additionally enable faster compliance with changes to customer contact preferences and regulatory changes. For example, a customer whose data is stored in corporate databases 114 requests to no longer be contacted by phone and instead to have all communications conducted by email. Digital customer consent engine 104 may enable the prompt processing of this requested change through a daily processing of data stored in corporate databases 114. Digital customer consent engine 104 may enable the prompt processing of the change in contact preferences to avoid employees annoying the customer with phone calls after the customer requested to cease receiving phone calls.

Digital customer consent engine 104 may enable more regular processing (e.g., daily) of customer data for identifying customers. For example, digital customer consent engine 104 may enable regular processing of customer data to quickly identify new customers who may have been recently added to corporate databases 114 and customers whose contact restrictions have recently changed (e.g., a customer moves to a state with more stringent requirements for calling customers during business hours). Digital customer consent engine 104 may enable more regular processing of customer data to improve response times to the receipt of new customer data. Digital customer consent engine 104 may enable the more regular processing of data to ensure the most accurate list of customers for a marketing campaign on any given day.

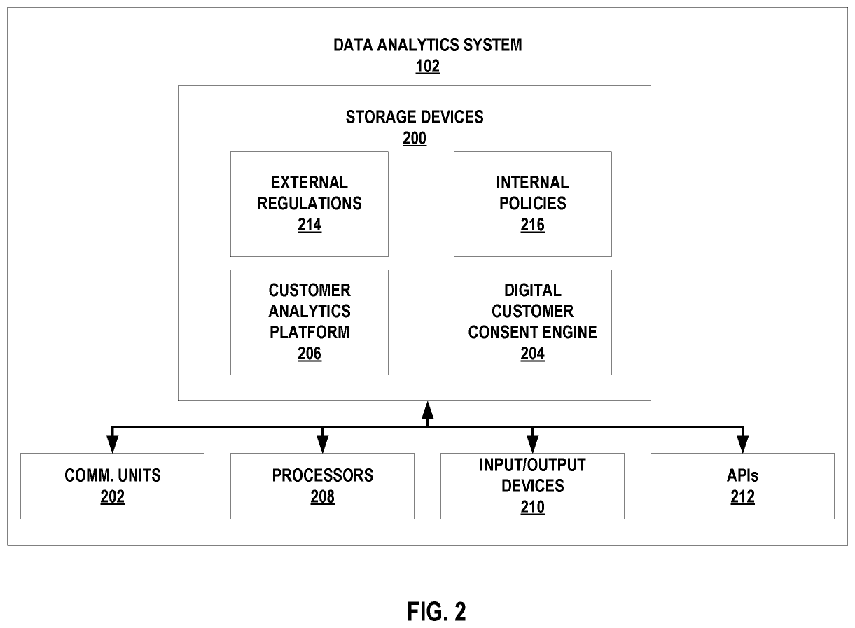

FIG. 2 is a block diagram illustrating an example data analytics system configured to execute the digital customer consent engine from FIG. 1. Data analytics system 102 may be a single server, cluster of servers, a virtualized computing environment, distributed computing environment, and/or the like. Data analytics system 102 is illustrated as a single computing device in FIG. 2 for purposes of illustration.

In the illustrated example of FIG. 2, data analytics system 102 includes storage devices 200, communication units 202, processors 208, input/output (I/O) devices 210, and application programming interfaces (APIs) 212. Storage devices 200 may comprise one or more storage mediums such as hard disk drives, solid state drives, tape storage, and other storage mediums. In some examples, storage devices 200 include one or more of a short-term memory or a long-term memory. Storage devices 200 may include, for example, random access memories (RAM), dynamic random-access memories (DRAM), static random-access memories (SRAM), magnetic discs, optical discs, flash memories, or forms of electrically programmable memories (EPROM) or electrically erasable and programmable memories (EEPROM). In some examples, storage devices 200 are used to store program instructions for execution by processors 208. Storage devices 200 may be used by software or applications running on data analytics system 102 (e.g., customer analytics platform 206 and digital customer consent engine 204) to temporarily store information during program execution. In the example of FIG. 2, storage devices 200 may include digital customer consent engine 204, customer analytics platform 206, external regulations 214, and internal policies 216. Customer analytics platform 206 may operate in a substantially similar to customer analytics platform 106 as illustrated in FIG. 1. Customer analytics platform 204 may provide customer data to digital customer consent engine 204 for use in identifying customer contact restrictions.

Communication units 202 may include one or more types of communication units. Communication units 202 may be network interfaces (such as Ethernet interfaces, optical transceivers, radio frequency (RF) transceivers, Wi-Fi or Bluetooth radios, or the like), telephony interfaces, or any other type of devices that can send and receive information. Data analytics system 102 may utilize communication units 202 and/or APIs 212 to communicate with other systems or devices via one or more connections or networks, e.g., marketing devices 112 and/or corporate databases 114 of FIG. 1.

Processors 208, in one example, may comprise one or more processors that are configured to implement functionality and/or process instructions for execution within data analytics system 102. For example, processors 208 may be capable of processing instructions stored by storage devices 200. Processors 208 may include, for example, microprocessors, digital signal processors (DSPs), application specific integrated circuits (ASICs), field-programmable gate array (FPGAs), or equivalent discrete or integrated logic circuitry, or a combination of any of the foregoing devices or circuitry.

I/O devices 210 may include one or more input devices and one or more output devices. I/O devices 210 may include input devices such as keyboards, mice, touchscreens, microphones, and other input devices. I/O devices 210 may include output devices such as display devices, speakers, and other output devices. I/O devices 210 may receive input or generate output in the form of text, audio, video, or images.

Data analytics system 102 may receive configurations of business logic via communication units 202 (e.g., from marketing devices 112 as illustrated in FIG. 1). Data analytics system 102 may provide the configured business logic to digital customer consent engine 204 for processing into rules. Digital customer consent engine 204 may operate in a substantially similar manner as digital customer consent engine 104 from FIG. 1. Digital customer consent engine 204 may obtain data regarding rules for identifying customer contact restrictions from regulations policies 214 and internal policies 216. External regulations 214 may include restrictions that originate from outside the organization on customer contact such as state and federal regulations on customer contact. Internal policies 216 may include organizational policies on customer contact, as well as customer contact preferences.

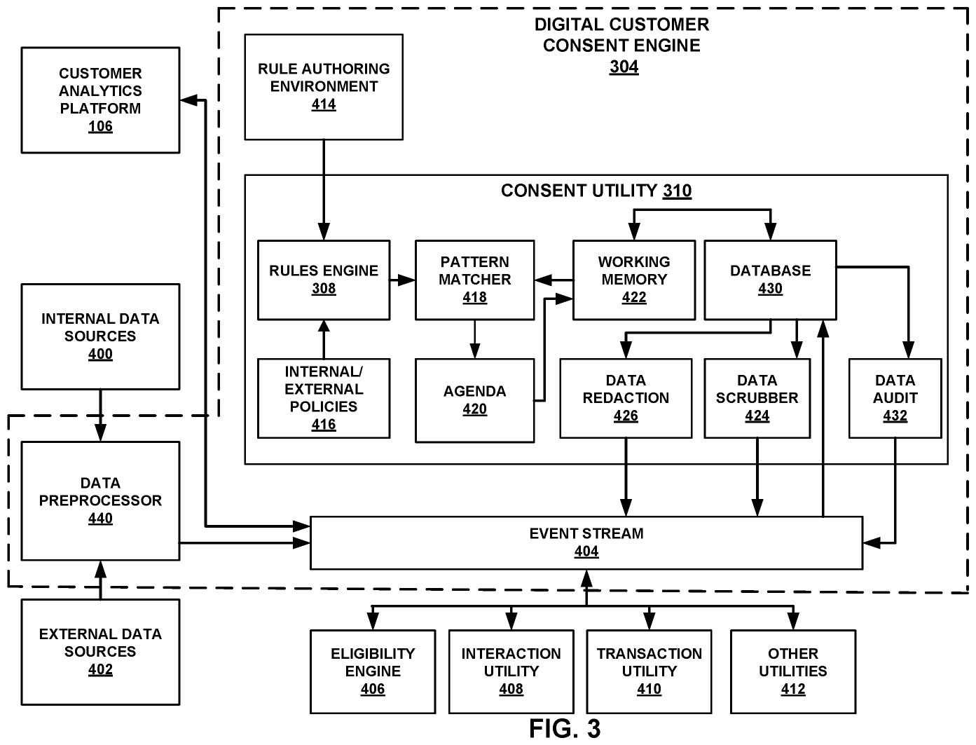

FIG. 3 is a block diagram illustrating an example of a digital customer consent engine, in accordance with one or more techniques of this disclosure. FIG. 3 illustrates digital customer consent engine 304, which operates substantially similar to digital customer consent engine 104 of FIG. 1 and/or digital customer consent engine 204 of FIG. 2. Digital customer consent engine 304 includes consent utility 310 which conducts the matching of rules to customer identifiers to identify customer contact restrictions for customers. Consent utility 310 may operate substantially similar to consent utility 110 from FIG. 1.

Digital customer consent engine 304 may receive customer data from one or more sources such as customer analytics platform 106, internal data sources 400, and external data sources 402. Digital customer consent engine may receive customer data from internal data sources 400 and external data sources 402 via data preprocessor 440. Data preprocessor 440 may process the customer data as the customer data may not be in the form or structure utilized by consent utility 310 (e.g., the customer data may not be organized utilizing the same data structure types used by consent utility 310, the customer data may not be organized by customer identifier, etc.). Responsive to the processing of the customer data, data preprocessor 440 may provide the data as a data stream to event stream 404 for use by consent utility 310. Consent utility 310 may obtain data such as customer data from event stream 404 as a data stream and store it for use in database 430. Consent utility 310 may apply the rules to the data in database 430.

Digital customer consent engine 304 may process business logic into rules for identifying customer contact restrictions from customer data received by event stream 404. Digital customer consent engine 304 may provide rules built in rule authoring environment 414 to rules engine 308. In addition, consent utility 310 may store customer contact restriction rules in internal/external policies 416. Rules engine 308 may acquire rules stored in internal/external policies 416 for use in identifying customer contact restrictions. In some examples, customer analytics platform 106 may facilitate modifications to existing rules in rules engine 308.

Upon receipt of a particular marketing campaign or other request, digital customer consent engine 304 may log the rules selected to be used for identifying customer contact restrictions for the particular marketing campaign or other request in pattern matcher 418. Consent utility 310 may apply the rules using pattern matcher 418 to the data hosted in database 430. Database 430 may include data provided by event stream 404. Consent utility 310 may apply the rules using waterfall logic. In an example, consent utility 310 has logged thirty rules in pattern matcher 418. Consent utility 310 may apply the rules in an iterative fashion using waterfall logic. Consent utility 310 may adjust the order of operations of the iterative application of the rules to the customer data in response to user configuration of the order of operations or automatically to ensure that customers are not accidently marked as eligible to be contacted.

Consent utility 310 may utilize working memory 422 in applying the rules to the customer data. Consent utility 310 may store the rules and customer data currently being matched in working memory 422 while pattern matcher 418 conducts the matching. Consent utility 310 may use agenda 420 to aid in managing the application of the rules and to determine and resolve any conflicts between the rules. Agenda 420 collects the results of the matching and pushes them back to working memory 422. Working memory 422 may then push the results to database 430 if the processing of customer data is complete, or to pattern matcher 418 for further processing of the customer data.

Consent utility 310 may apply the rules to the customer data and identify which customers have the customer contact restrictions identified by the associated rules (e.g., a rule designed to identify customers with auto loans in good standing). Responsive to the application of the rules to customer data, consent utility 310 may generate a list of customers along with indicators as to which contact restrictions apply to each of the customers based on data stored in database 430. Consent utility 310 may output the list of customers from database 430 to data redaction 426 and data scrubber 424.

Consent utility 310 may use data redaction 426 and data scrubber 424 to process the list of customers before providing the lists of customers to event stream 404. Consent utility 310 may use data redaction 426 to process customer lists and remove customers from the list in accordance with the customer contact restrictions. In an example, a list of customers includes customers that are on a federal do-not-contact list. Data redaction 426 may remove those customers from the list of customers before providing the list to event stream 404 to ensure that those customers are not contacted.

Consent utility 310 may utilize data scrubber 424 to output lists of customers with particular types of contact removed from the list in accordance with customer contact restrictions. For example, data scrubber 424 may remove customers' phone numbers from the list of customers in response to a customer contact restriction for contact by telephone. Data scrubber 424 may then output the list of customers with phone numbers removed in accordance with the customer contact restrictions to event stream 404 for use in contacting customers. Consent utility 310 may use data audit 432 to log the reports of customer identifiers for use in auditing customer contacts. For example, data audit 432 may log the indicators of customer contact restrictions for a particular customer for review and auditing. Consent utility 310 may output reports to event stream 404 following the generation of the reports. Consent utility 310 may output reports and other data to event stream 404 for usage by other computing devices and utilities such as eligibility engine 406, interaction utility 408, transaction utility 410, and other utilities 412.

Consent utility 310 may process updates to customer data and customer contact restrictions and output updated reports of customer contact restrictions and customer identifiers. For example, consent utility 310 may receive second customer data at a second point in time that includes a change in contact preferences for a particular customer. Consent utility 310 may receive second customer data that includes a change in contact preferences such as a do-not-contact preference for one or more types of contact channels (e.g., telephone, email, mail, etc.). Consent utility 310 may apply the one or more rules to the second customer data such as applying a rule to identify a do-not-call preference restriction (e.g., a customer contact restriction) for the particular customer. Consent utility 310, responsive to the application of the one or more rules to the second customer data, may output a report that does not include the one or more types of contact channels for the particular customer identifier for the particular customer.

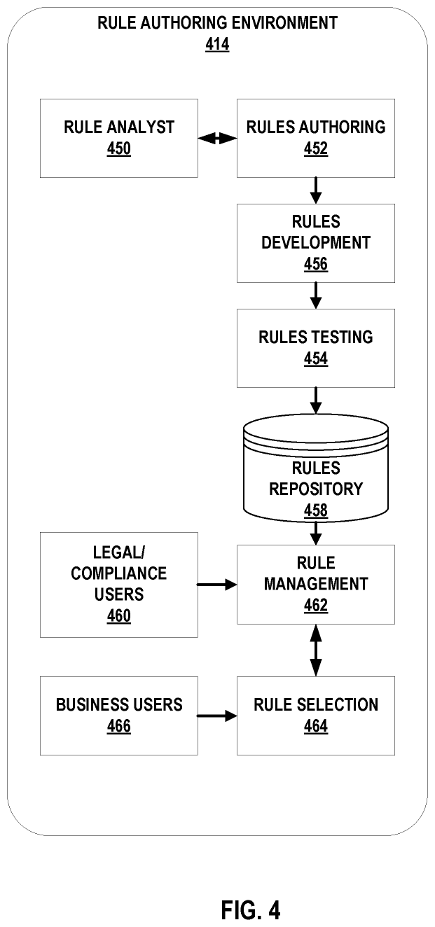

FIG. 4 is a block diagram illustrating an example operation of a rule authoring environment of the digital customer consent engine from FIG. 1. Rule authoring environment 414 includes rule analyst 450, rules authoring 452, rules testing 545, rules development 456, rules repository 458, legal/compliance users 460, rule management 462, rule selection 464, and business users 466.

Rule authoring environment 414 may enable users to generate new rules through a rule authoring environment. Rule authoring environment 414 may enable organizations to validate new rules and business logic before the new rules are deployed for identification of customer contact restrictions. Rule authoring environment 414 may enable organizations to conduct validation such as regulatory compliance, verifying functionality (i.e., ensuring the business logic and associated rule result in the desired output), and other validation and compliance verification.

Rule authoring environment 414 may process the user-configured business logic into rules for identifying customers. Rule authoring environment 414 may process the user-configured business logic into code representative of rules for identifying customer contact restrictions. Rule authoring environment 414 may compile the code and test the code before deploying it to consent utility 310.

Rule authoring environment 414, as part of authoring the one or more rules, may include receiving, via a user interface of a user computing device such as marketing devices 112 as illustrated in FIG. 1, a request to create a rule based on one or more requirements for customer contact. Rule authoring environment 414 may create, based on the request, at least one rule to identify at least one customer trait that corresponds to the one or more requirements for the marketing campaign without requiring software development or further input from a user. Rule authoring environment 414 may maintain the rule in addition to the one or more rules and provide the rules to consent utility 310 as illustrated in FIG. 3.

Rule analyst 450 may represent one or more users of digital customer consent engine 304 such as the users of marketing devices 112 as illustrated in FIG. 1. Rule analyst 450 may provide input to rules authoring 452 via one or more computing devices such as marketing devices 112. Rules authoring 452 may enable users to configure business logic that implements the one or more rules governing customer contact restrictions. Rules development 456 may enable the development of business logic into rules for application by consent utility 310. Rules development 456 may include the processing of business logic into the code necessary to implement the identification of customer contact restrictions.

Rules testing 454 may enable validation of rules before they are utilized by digital customer consent engine 304. Rules testing 454 may enable organizations to validate rules and ensure that developed rules meet relevant internal policies and regulatory requirements. Rules testing 454 may provide the validated rules to rules repository 458 for deployment to consent utility 310.

Rule authoring environment 414, as part of maintaining the one or more rules may store a plurality of rules. Rule authoring environment 414 may store the rules for use by digital customer consent engine 314 and configuration by users such as the users of marketing device 112. Rules repository 458 may output rules to rule management 462 for users to manage the selection of rules for application to customer data. Legal/compliance users 460 may configure the rules selected for application to ensure that the rules meet regulatory requirements.

Business users 466 may utilize rule selection 464 to select rules for application to customer data. Rule selection 464 may enable users to configure business logic representative of rules for identifying customer contact restrictions from customer data. Rule selection 464 generates data representative of a user interface to enable users to configure the business logic and select among existing rules using user interface elements of the user interface such as fillable forms, drop-down menus, interactive user interface elements (e.g., clickable buttons), interactive text entry with language recognition (e.g., a text box where a user can type contact restrictions such as “customer has requested to not be contacted by email”), and business programming entry (e.g., using high-level business programming languages) among other types of user interaction. Rule selection 464 may provide the selected rules to rule management 462 for validation by legal/compliance users 460 before providing the selected rules to consent utility 310.

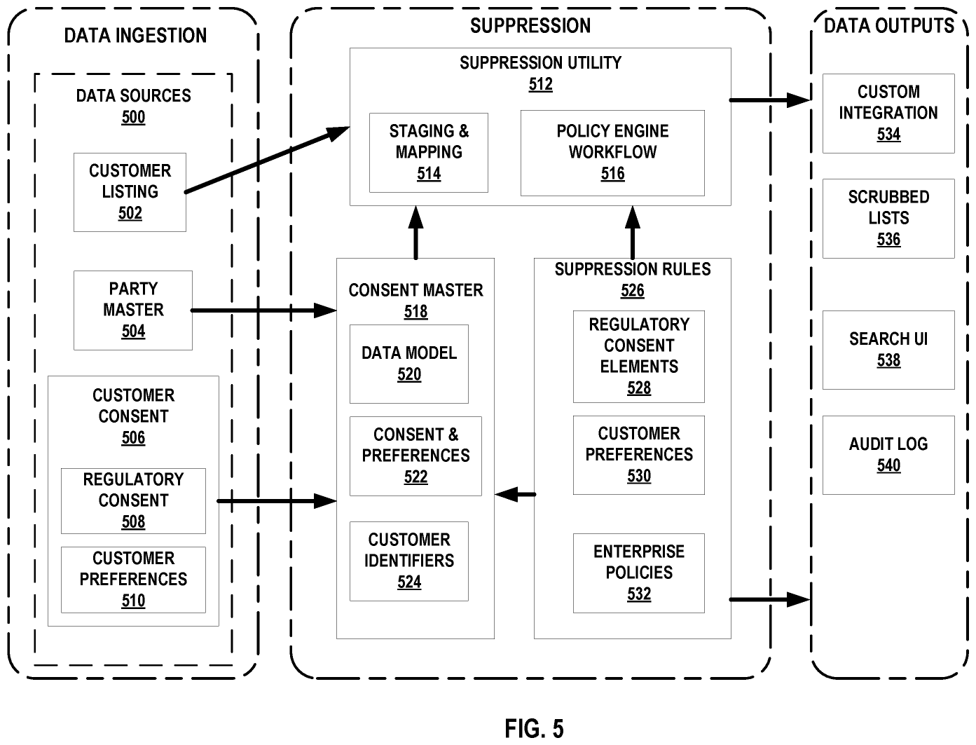

FIG. 5 is a block diagram illustrating an example operation of the digital customer consent engine 104 from FIG. 1 configured to maintain rules configured to identify customer contact restrictions and apply the rules to customer to data to identify customers having the customer contact restrictions, in accordance with one or more techniques of this disclosure.

FIG. 5 illustrates stages of operation of the digital customer consent engine 104 from FIG. 1 as “Data Ingestion”, “Suppression”, and “Data Outputs”. Data Ingestion represents the ingestion of customer data and rules by the digital customer consent engine such as digital customer consent engine 104 as illustrated in FIG. 1. Data Ingestion includes data sources 500. Data sources 500 include customer listing 502, party master 504, and customer consent 506. Customer listing 502 may include customer data such as data from corporate databases 114 as illustrated in FIG. 1 as well as data such as marketing lists. Party master 504 may include lists of customers identified by customer identifier. Party master 504 may provide lists of customers that identify individual customers by customer identifier and associate customer data with the individual customers.

Customer consent 506 includes regulatory consent 508 and customer preferences 510. Customer consent 506 may represent the rules for determining customer contact preferences. Regulatory consent 508 may include regulatory restrictions on customer contacts such as state and federal regulations on customer contact (e.g., do-not-call lists, time of day restrictions on contact, etc.). Customer preferences 510 may include customer contact preferences of an organization's customers. For example, customer preferences 510 may store a customer's request to not be contacted by phone or to be unsubscribed from email messages.

Suppression may represent the one or more operations of digital customer consent engine 304 in identifying customer contact restrictions for customers. Suppression includes suppression utility 512, consent master 518, and suppression rules 526. Suppression rules 526 may include regulatory consent elements 528, customer preferences 530, and enterprise policies 532. Regulatory consent elements 528 may include rules for implementing various regulatory requirements for customer contact. Customer preferences 530 may include rules that implement customer contact preferences. Enterprise policies 532 may include rules that implement various organization-specific requirements for contact customers (e.g., a company policy not to contact customers after 5 PM local time).

Consent master 518 may include data model 520, consent & preferences 522, and customer identifiers 524. Consent master 518 may obtain the rules for customer contact from suppression rules 526. Consent master 518 may assist suppression utility 512 in identifying customer contact restrictions for individual customers within the customer data.

Data model 520 may model various business elements against which customer contact consent is obtained. Consent & preferences 522 may include data regarding customer contact preferences obtained from customer preferences 510. Customer identifiers 524 may include the customer identification numbers used to identify individual customers and associate customer data with the individual customers.

Suppression utility 512 may process customer data and determine customer contact restrictions for customers. Suppression utility include staging & mapping 514 and policy engine workflow 516. Staging & mapping 514 may intake data such as customer data and the rules used to identify customer contact restrictions and prepare the data for processing by policy engine workflow 516. Policy engine workflow 516 may conduct the matching of rules to customer data and determine customer contact restrictions.

Data outputs may represent the output of digital customer consent engine 104. Data outputs may include customer integration 534, scrubbed lists 536, search UI 538, and audit log 540. Custom integration 534 may include one or more integrations of other components with digital customer consent engine 104 to utilize the output of digital customer consent engine 104. Custom integration 534 may include integrations such as UI-based alerts, logical/soft deletion, masking, and other integrations. Scrubbed lists 536 may include outputs of customer lists where the list includes customer contact details that have been scrubbed to remove contact details to comply with customer contact restrictions. For example, scrubbed lists 536 may output a customer list that comprises a list of customer identifiers that are permitted to be contacted for a marketing campaign. Search UI 538 may include a user interface to enable users to search for particular customers and their associated customer contact restrictions.

Audit log 540 may store logs of the output of suppression utility 512 for use in auditing and reviewing lists of customers with contact restrictions. Audit log 540 may store logs that record the results of suppression utility 512 such as the reasons for indicating a customer has contact restrictions. For example, audit log 540 may store a log of a report comprising a plurality of customer identifiers that includes an indicator for each particular customer identifier that indicates which customer contact restrictions apply to the particular customer.

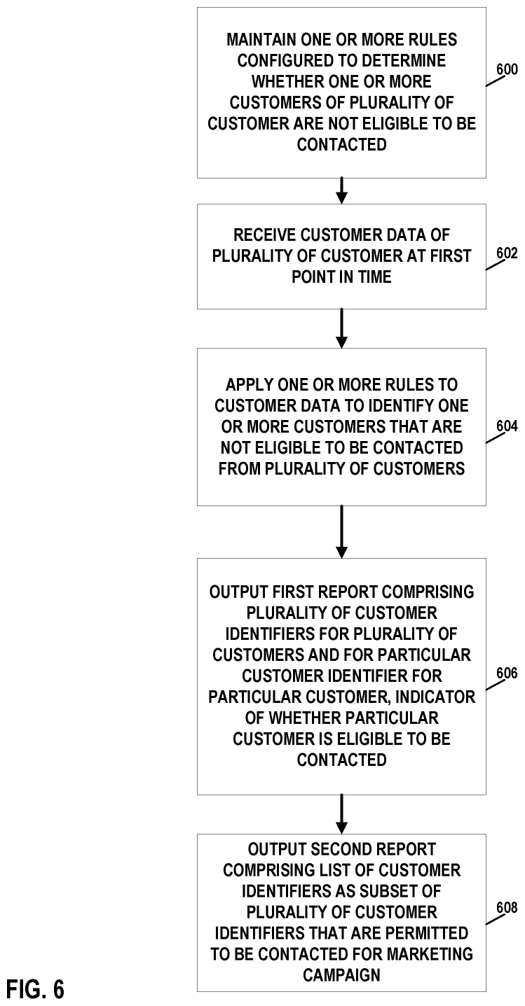

FIG. 6 is a flowchart illustrating an example operation of a digital customer consent engine, in accordance with one or more techniques of this disclosure. The example operation of FIG. 6 is described with respect to digital customer consent engine 104 of FIG. 1. In other examples, the operation of FIG. 6 may be performed by digital customer consent engine 204 of FIG. 2 or digital customer consent engine 304 of FIG. 3.

Digital customer consent engine 104 maintains rules configured to determine whether one or more customers of a plurality of customer are not eligible to be contacted (600). Digital customer consent engine 104 may maintain rules that are derived from user-configured business logic. Digital customer consent engine 104, responsive to the receipt of user-configured business logic, may process the business logic into the rules maintained by digital customer consent engine 104.

Digital customer consent engine 104 receives customer data of a plurality of customers at a first point in time (602). Digital customer consent engine 104 may receive customer data from one or more sources such as databases within an organization's internal network. Digital customer consent engine 104 may receive a variety of customer data such as mortgage data, credit history, banking data, customer demographics, customer contact preferences, place of residence, and other types of customer data. Digital customer consent engine 104 may receive the customer data as a data stream from one or more databases. Additionally, digital customer consent engine 104 may receive customer data on a regular basis such as daily, biweekly, and weekly. Digital customer consent engine 104 may determine whether received customer data is an update to previously received customer data and determine the delta between the newly received customer data and previously received customer data. Digital customer consent engine 104 may purge previously received customer data at predetermined intervals.

Digital customer consent engine 104 applies the rules to the customer data to identify one or more customers that are not eligible to be contacted from the plurality of customers (604). Digital customer consent engine 104 may apply the rules using a rules engine 308 and a pattern matcher 418 that matches the rules to customer data and ensures that there are no conflicts between the rules. Digital customer consent engine 104 may apply the rules to customer data using parallel processing and waterfall logic. In addition, digital customer consent engine 104 may apply the rules to the customer data in real-time as the customer data is received by the digital customer consent engine.

Responsive to the processing of the customer data, digital customer consent engine 104 outputs a first report comprising a plurality of customer identifiers for the plurality of customers and, for a particular customer identifier, an indicator of whether the particular customer is eligible to be contacted (606). Digital customer consent engine 104 also outputs a second report comprising a list of customer identifiers as a subset of the plurality of customer identifiers that are permitted to be contacted for a marketing campaign (608). Digital customer consent engine 104 may output the first and second reports to other computing devices such as marketing devices used by marketing teams or via one or more APIs to other computing devices. Digital customer consent engine 104 may output the first and second reports as data for a UI.

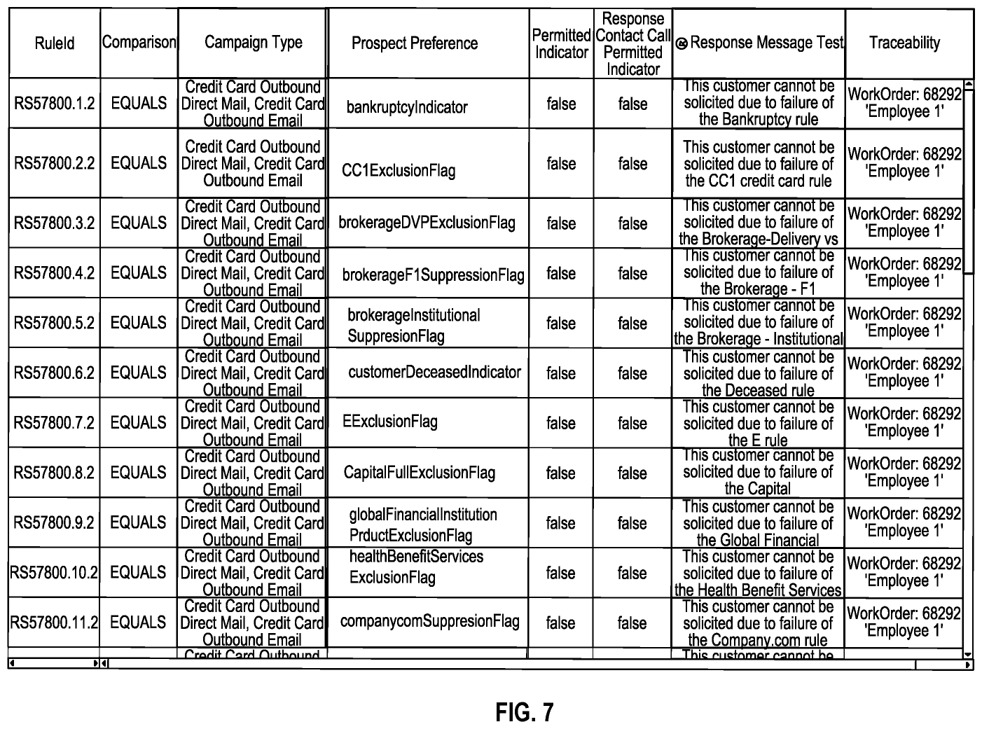

FIG. 7 is an example user interface of the digital customer consent engine illustrating an example listing of rules configured to identify customer contact restrictions. The illustrated user interface includes a list of rules organized by rule id. The illustrated user interface also includes several example characteristics of the rules such as “bankruptcy Indicator” corresponding to “This customer cannot be solicited due to failure of the Bankruptcy rule.” The digital customer consent engine may enable users to configure the rules using a user interface such as the one illustrated by FIG. 7.

Various examples have been described. These and other examples are within the scope of the following claims. For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

For ease of illustration, only a limited number of devices (e.g., corporate databases 114, data analytics system 102, marketing devices 112, as well as others) are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each depict at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the illustrations and/or may include additional devices and/or components not shown in the illustrations.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated in the Figures herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In accordance with one or more aspects of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses. Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

1. A method comprising:
maintaining, by a computing system, one or more rules configured to identify one or more customer contact restrictions from customer data;
receiving, by the computing system, customer data of the plurality of customers at a point in time;
applying, by the computing system, the one or more rules to the customer data to identify the one or more customer contact restrictions for one or more customers of the plurality of customers;
outputting, by the computing system, a first report comprising a plurality of customer identifiers for the plurality of customers, and for a particular customer identifier for a particular customer, an indicator of which customer contact restrictions apply to the particular customer; and
outputting, by the computing system, a second report comprising a list of customer identifiers as a subset of the plurality of customer identifiers that are permitted to be contacted for a marketing campaign.

2. The method of claim 1, wherein maintaining the one or more rules comprises:
receiving, via a user interface from a user computing device, a request to modify a first rule of the one or more rules;
modifying, based on the receiving, the first rule to create a second rule without further requiring software development or further input from a user; and
maintaining the second rule such that the first rule is replaced by the second rule within the one or more rules.

3. The method of claim 1, wherein maintaining the one or more rules comprises:
receiving, by the computing system, data regarding one or more regulatory requirements;
creating, by the computing system, at least one rule to implement the regulatory requirement without requiring software development or further input from a user; and
maintaining, by the computing system, the rule in addition to the one or more rules.

4. The method of claim 1, further comprising:
receiving, by the computing system, one or more contact requirements for the contact campaign; and
selecting, by the computing device, a set of rules from the one or more rules, wherein the set of rules identify a set of customer contact restrictions for compliance by the contact campaign,
wherein applying the one or more rules to the customer data comprises:
comparing, by the computing system, the set of rules to at least a portion of the customer data indicating contact restrictions for the particular customer; and
determining, by the computing system and based on the comparison, that the particular customer is permitted to be contacted for the contact campaign, and
wherein outputting the second report comprises outputting, by the computing system and based on the determination, a second report that includes the particular customer identifier of the particular customer.

5. The method of claim 1, further comprising:
receiving, by the computing system, one or more contact requirements for the contact; and
selecting, by the computing device, a set of rules from the one or more rules, wherein the set of rules identify a set of customer contact restrictions for compliance by the contact campaign,
wherein applying the one or more rules to the customer data comprises:
comparing, by the computing system, the set of rules to at least a portion of the customer data indicating contact restrictions for the particular customer; and
determining, by the computing system and based on the comparison, that the particular customer is not permitted to be contacted, and
wherein outputting the second report comprises outputting, by the computing system and based on the determination, a second report that does not include the particular customer identifier of the particular customer.

6. The method of claim 1, comprising:
determining, by the computing system, that a first rule of the one or more rules is in conflict with a second rule;
identifying, by the computing system, which of the first rule or the second rule would result in more customers of the plurality of customers being indicated as having at least one customer contact restriction; and
selecting, by the computing system, the one of the first rule or the second rule that would result in more customers that are permitted to be contacted.

7. The method of claim 1, further comprising:
receiving, by the computing system, do-not-contact list data for the particular customer of the plurality of customers; and
associating, by the computing system, the do-not-contact list data with the particular customer identifier of the particular customer,
wherein applying the one or more rules to the customer data comprises applying a rule to identify a do-not-call list restriction for the particular customer, and
wherein outputting the second report comprises outputting a second report that does not include the particular customer identifier of the particular customer.

8. The method of claim 1, wherein the customer data is a first customer data, the method further comprising:
receiving, by the computing system, second customer data at a second point in time, wherein the second customer data includes a change in contact preferences for the particular customer, wherein the change in contact preferences indicates a do-not-contact preference for one or more types of contact channels; and
applying, by the computing system, the one or more rules to the second customer data,
wherein applying the one or more rules to the customer data comprises applying a rule to identify a do-not-call preference restriction for the particular customer, and
wherein outputting the second report comprises outputting a second report that does not include the one or more types of contact channels for the particular customer identifier of the particular customer.

9. The method of claim 1, wherein outputting the first report comprises outputting the first report for inclusion in an audit log of the customer contact restrictions applied to the one or more customers.

10. The method of claim 1, wherein the first report includes, for each indicator of which customer contact restrictions apply to the particular customer, a reason why the particular customer is not permitted to be contacted for the contact campaign.

11. The method of claim 1, wherein applying the one or more rules to the customer data comprises applying the one or more rules to a data stream of the customer data in real-time.

12. The method of claim 1, wherein outputting the second report comprises outputting the second report via an API to one or more services.

13. A computing system, comprising:
a memory; and
one or more processors in communication with the memory, and configured to:
maintain one or more rules configured to identify one or more customer contact restrictions from customer data;
receive customer data of the plurality of customers at a point in time;
apply the one or more rules to the customer data to identify the one or more customer contact restrictions for one or more customers of the plurality of customers;
output a first report comprising a plurality of customer identifiers for the plurality of customers, and for a particular customer identifier for a particular customer, an indicator of which customer contact restrictions apply to the particular customer; and
output a second report comprising a list of customer identifiers as a subset of the plurality of customer identifiers that are permitted to be contacted for a contact campaign.

14. The computing system of claim 13, wherein the one or more processors are further configured to:
receive one or more contact requirements for the contact campaign; and
select a set of rules from the one or more rules, wherein the set of rules identify a set of customer contact restrictions for compliance by the contact campaign,
wherein to apply the one or more rules to the customer data, the one or more processors are configured to:
compare the set of rules to at least a portion of the customer data indicating contact restrictions for the particular customer; and
determine, based on the comparison, that the particular customer is permitted to be contacted for the contact campaign, and
wherein to output the second report, the one or more processors are configured to output, based on the determination, a second report that includes the particular customer identifier of the particular customer.

15. The computing system of claim 13, wherein the one or more processors are further configured to:
receive one or more contact requirements for the contact; and
select a set of rules from the one or more rules, wherein the set of rules identify a set of customer contact restrictions for compliance by the contact campaign,
wherein to apply the one or more rules to the customer data, the one or more processors are configured to:
compare the set of rules to at least a portion of the customer data indicating contact restrictions for the particular customer; and
determine, based on the comparison, that the particular customer is not permitted to be contacted, and
wherein to output the second report, the one or more processors are configured to output, based on the determination, a second report that does not include the particular customer identifier of the particular customer.

16. The computing system of claim 13, wherein the one or more processors are further configured to:
determine that a first rule of the one or more rules is in conflict with a second rule;
identify which of the first rule or the second rule would result in more customers of the plurality of customers being indicated as having at least one customer contact restriction; and
select the one of the first rule or the second rule that would result in more customers that are permitted to be contacted.

17. The computing system of claim 13, wherein the one or more processors are further configured to:
receive do-not-contact list data for the particular customer of the plurality of customers; and
associate the do-not-contact list data with the particular customer identifier of the particular customer,
wherein to apply the one or more rules to the customer data, the one or more processors are configured to apply a rule to identify a do-not-call list restriction for the particular customer, and
wherein to output the second report, the one or more processors are configured to output a second report that does not include the particular customer identifier of the particular customer.

18. The computing system of claim 13, wherein the customer data is a first customer data, and wherein the one or more processors are further configured to:
receive second customer data at a second point in time, wherein the second customer data includes a change in contact preferences for the particular customer, wherein the change in contact preferences indicates a do-not-contact preference for one or more types of contact channels; and
apply the one or more rules to the second customer data,
wherein to apply the one or more rules to the customer data, the one or more processors are configured to apply a rule to identify a do-not-call preference restriction for the particular customer, and
wherein to output the second report, the one or more processors are configured to output a second report that does not include the one or more types of contact channels for the particular customer identifier of the particular customer.

19. The computing system of claim 13, wherein to output the second report, the one or more processors are configured to output the second report via an API to one or more services.

20. A non-transitory computer-readable storage medium comprising instructions that, when executed, cause one or more processors to:
maintain one or more rules configured to identify one or more customer contact restrictions from customer data;
receive customer data of the plurality of customers at a point in time;
apply the one or more rules to the customer data to identify the one or more customer contact restrictions for one or more customers of the plurality of customers;
output a first report comprising a plurality of customer identifiers for the plurality of customers, and for a particular customer identifier for a particular customer, an indicator of which customer contact restrictions apply to the particular customer; and
output a second report comprising a list of customer identifiers as a subset of the plurality of customer identifiers that are permitted to be contacted for a contact campaign.
